(19) United States
(12) Patent Application Publication
(10) Pub. No.: US 2026/0113725 A1
(43) Pub. Date: Apr. 23, 2026

(54) METHOD FOR SIDELINK-AIDED MULTI-ROUND TRIP TIME POSITIONING WITH SERVING GNB INVOLVEMENT

(71) Applicant: Continental Automotive Technologies GmbH, Hannover (DE)

(72) Inventors: Reuben George Stephen, Singapore (SG); David Gonzalez Gonzalez, Egelsbach (DE); Rikin Shah, Langen (DE)

(73) Assignee: Continental Automotive Technologies GmbH, Hannover (DE)

(21) Appl. No.: 19/116,056

(22) PCT Filed: Sep. 26, 2023
(86) PCT No.: PCT/EP2023/076528

§ 371 Date: Mar. 27, 2025

(30) Foreign Application Priority Data
Sep. 27, 2022 (SG) 10202251184K

(51) Int. Cl. H04W 64/00; H04L 47/283; H04W 72/25

(52) U.S. Cl. CPC H04W 64/00; H04L 47/283; H04W 72/25

(57) ABSTRACT

Methods for Sidelink-Aided multi-Round Trip Time Positioning (RTT) with at least one serving gNB involvement in a wireless communication system, characterized by, that single-sided or double-side multi-round trip time (RTT)-of wireless communication signals-based positioning involving the sidelink (SL) in the wireless communication system in coordination with at least one base-station (gNB) is proceeded by using an initiator node and the position of a target user equipment (UE) is computed.

### TECHNICAL FIELD

The present disclosure relates generally to wireless communications and more particularly Sidelink-Aided Multi-Round Trip Time Positioning. Wireless communication systems have developed through various generations, including a first-generation analog wireless phone service (1G), a second-generation (2G) digital wireless phone service (including interim 2.5G networks), a third-generation (3G) high speed data, Internet-capable wireless service and a fourth-generation (4G) service (e.g., LTE or WiMax). There are presently many different types of wireless communication systems in use, including cellular and personal communications service (PCS) systems. Examples of known cellular systems include the cellular Analog Advanced Mobile Phone System (AMPS), and digital cellular systems based on code division multiple access (CDMA), frequency division multiple access (FDMA), time division multiple access (TDMA), the Global System for Mobile access (GSM) variation of TDMA, etc.

A fifth generation (5G) wireless standard, referred to as New Radio (NR), enables higher data transfer speeds, greater numbers of connections, and better coverage, among other improvements. The 5G standard, according to the Next Generation Mobile Networks Alliance, is designed to provide data rates of several tens of megabits per second to each of tens of thousands of users, with 1 gigabit per second to tens of workers on an office floor. Several hundreds of thousands of simultaneous connections should be supported in order to support large wireless deployments. Consequently, the spectral efficiency of 5G mobile communications should be significantly enhanced compared to the current 4G standard. Furthermore, signaling efficiencies should be enhanced and latency should be substantially reduced compared to current standards.

Leveraging the increased data rates and decreased latency of 5G, among other things, vehicle-to-everything (V2X) communication technologies are being implemented to support autonomous driving applications, such as wireless communications between vehicles, between vehicles and the roadside infrastructure, between vehicles and pedestrians, etc.

Obtaining accurate position information for user equipment, such as cellular telephones or other wireless communication devices, is becoming prevalent in the communications industry. For example, obtaining highly accurate locations of vehicles or pedestrians is essential for autonomous vehicle driving and pedestrian safety applications.

A common means to determine the location of a device is to use a satellite positioning system (SPS), such as the well-known Global Positioning Satellite (GPS) system or Global Navigation Satellite System (GNSS), which employ a number of satellites that are in orbit around the Earth. In certain scenarios, however, location determination signals from an SPS may be unreliable or unavailable, e.g., during adverse weather conditions or in areas with poor satellite signal reception such as tunnels or parking complexes. Moreover, position information generated using SPS is prone to imprecision. For example, off-the-shelf GPS positioning devices have an accuracy of a few meters, which is not optimal to ensure safe autonomous driving and navigation.

Coordinated or automated driving requires communications between vehicles, which may be direct or indirect, e.g., via an infrastructure component such as a roadside unit (RSU). For vehicle safety applications, both positioning and ranging are important. For example, vehicle user equipments (UEs) may perform positioning and ranging using sidelink signaling, e.g., broadcasting ranging signals for other vehicle UEs or pedestrian UEs to determine the relative location of the transmitter. An accurate and timely knowledge of the relative locations or ranges to nearby vehicles, enables automated vehicles to safely maneuver and negotiate traffic conditions. Round trip time (RTT), for example, is a technique commonly used for determining a range between transmitters. RTT is a two-way messaging technique in which the time between sending a signal from a first device to receiving an acknowledgement from a second device (minus processing delays) corresponds to the distance (range) between the two devices. While RTT is accurate, it would be desirable to reduce the power consumption required by two way messaging.

### BACKGROUND

Wireless communication systems are widely deployed to provide various telecommunication services such as telephony, video, data, messaging, positioning, and broadcasts. Typical wireless communication systems may employ multiple-access technologies capable of supporting communication with multiple users by sharing available system resources (e.g., bandwidth, transmit power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems.

A wireless multiple-access communication system may include a number of base stations, each simultaneously supporting communication for multiple communication devices, otherwise known as user equipment (UEs). In LTE or LTE-A network, a set of one or more base stations may define an e NodeB (eNB). In other examples (e.g., in a next generation or 5G network), a wireless multiple access communication system may include a number of distributed units (DUs) (e.g., edge units (EUs), edge nodes (ENs), radio heads (RHs), smart radio heads (SRHs), transmission reception points (TRPs), etc.) in communication with a number of central units (CUs) (e.g., central nodes (CNs), access node controllers (ANCs), etc.), where a set of one or more distributed units, in communication with a central unit, may define an access node (e.g., a new radio base station (NR BS), a new radio node-B (NR NB), a network node, 5G NB, gNB, etc.). A base station or DU may communicate with a set of UEs on downlink channels (e.g., for transmissions from a base station or to a UE) and uplink channels (e.g., for transmissions from a UE to a base station or distributed unit). Additionally, UEs may communicate directly with each other using sidelink channels.

The location of UE may be useful or essential to a number of applications including emergency calls, navigation, direction finding, asset tracking and Internet service. The location of a UE may be estimated based on information gathered from various systems. In a cellular network implemented according to LTE or 5G NR, for example, a base station may send downlink reference signals with which positioning measurements are performed by a UE and/or the UE may send uplink reference signals with which positioning measurements are performed by the base stations. Additionally, sidelink reference signals may be transmitted by UEs and positioning measurements performed by a UE. The UE may compute an estimate of its own location using the positioning measurements in UE-based positioning or may send the positioning measurements to a network entity, e.g., location server, which may compute the UE location based on the positioning measurements in UE-assisted positioning.

Various positioning techniques can be employed for determining the position of a wireless communication device (e.g., a wireless local area network (WLAN) device) based on receiving wireless communication signals. For example, positioning techniques can be implemented that utilize time of arrival (TOA), the round trip time (RTT) of wireless communication signals, received signal strength indicator (RSSI), or the time difference of arrival (TDOA) of the wireless communication signals to determine the position of a wireless communication device in a wireless communication network. These positioning techniques are dependent on precise time measurements and therefore may be sensitive to variations in hardware and/or software configurations of the wireless communication devices. The accuracy of the positioning results may vary, for example, based on device model, software version, or manufacturer.

It may be desirable for positioning improvements implemented in newer technologies, such as 5G NR, to assist in positioning of multiple UEs more efficiently.

FIG. 1 shows the type of TOA measurement. FIG. 1a shows two-way ranging and FIG. 1b shows requester sends a request packet to the responder, which replies after a response time Rj with a response packet and therefore the time lapse between instant when signal is transmitted and instant when response to transmitted signal received can be calculated. Ideally RTT=2×TOA and this means that no synchronization requirements between transmitter and receiver need to be supplied. This means in practice RTTᵢ=Tᵢ(t₃)−Tᵢ(t₀). FIG. 1c shows double-sided two-way ranging (Double-sided RTT). Extra reply sent by node i to j, node j can then calculate RTTⱼ, and in this case residual error is lower than conventional two-way ranging (RTT).

FIG. 2 shows multi-RTT and the serving cell RTT measurement process is explained. In the first time frame, i, the gNB measures its Rx-Tx time difference and sees it is different from zero. Thus, it sends a timing advance adjustment command to the mobile device. In time frame i+1, the uplink timing of the mobile device is corrected and the gNB Rx-Tx time difference is zero. Hence, the UE Rx-Tx time difference is exactly the RTT. Positioning method introduced in 5G NR and defines procedure to perform RTT measurements on neighbor base stations, enabling trilateration.

The measurements reported to the Location Management Function (LMF):
A: UE reports t₃−t₀
B: gNB reports t₂−t₁
LMF calculates RTT by

$$RTT = A - B = ( {t}_{3} - {t}_{0} ) - ( {t}_{2} - {t}_{1} )$$

FIG. 2a shows RTT measurement process to the serving base station and FIG. 2b shows RTT measurement process to neighbor base stations.

In this context Target UE means UE to be positioned (in this context, using SL, i.e., PC5 interface) and Anchor UE means UE supporting positioning of target UE, e.g., by transmitting and/or receiving reference signals for positioning, providing positioning-related information, etc., over SL interface and Sidelink positioning means Positioning UE using reference signals transmitted over SL, i.e., PC5 interface, to obtain absolute position, relative position, or ranging information and Ranging means determination of the distance and/or the direction between a UE and another entity, e.g., anchor UE.

FIG. 3 shows absolute positioning based on multi-RTT and FIG. 3a shows the existing Multi-RTT distance-based absolute positioning based on multi-RTT possible if there are at least three neighboring gNBs. If not enough neighboring gNBs are existing, absolute positioning with multi-RTT cannot be performed. FIG. 3b shows Sidelink-Aided Multi-RTT. Using sidelink (SL) for multi-RTT solves this problem since RTT measurements to anchor UEs can be used instead.

Straightforward approach to include SL: RTT signals and measurements to be exchanged between each anchor node and target UE individually; drawbacks the need to allocate resources for SL-PRS, measurement reporting, etc. separately for each anchor UE and with current SL resource allocation (especially in mode 2) target and anchor UEs need to sense and transmit over SL for each RTT measurement. This means the need of efficient resource allocation and message exchange protocols for sidelink-aided multi-RTT when serving gNB is involved.

US2022150863 A1 discloses a method being performed by a first station and comprises: transmitting a first message including an indication of whether a clock reconfiguration event occurs at the first station; transmitting a first positioning reference signal (PRS); receiving from a second station a second PRS; and transmitting to the second station a second message including a first time when the first PRS is transmitted by the first station and a second time when the second PRS is received by the first station, to enable the second station to determine a roundtrip time (RTT) between the first station and the second station based on the first time, the second time, a third time when the second station receives the first PRS, a fourth time when the second station transmits the second PRS, and the indication.

WO 2022027298 A1 discloses that a UE transmits an SL RTT measurement request to at least one UE. The UE communicates (e.g., transmits, receives, or both), with the at least one UE in response to the SL RTT measurement request, an indication of an SL RTT measurement (e.g., Rx-Tx time difference measurement for RTT).

WO 2020256311 A1 discloses a method of operating a first terminal in a wireless communication system. The method may comprise: a step for transmitting a first PRS to a second terminal; a step for receiving a second PRS from the second terminal; a step for receiving a first time difference from the second terminal; and a step for determining a location of the first terminal on the basis of the first time difference and a second time difference.

WO 2021188220 A1 discloses techniques for wireless communication. In an aspect, a first user equipment (UE) transmits a request to perform a positioning procedure to at least one second UE over a sidelink between the first UE and the at least one second UE, receives, from the at least one second UE over the sidelink, an indication of a set of time resources, frequency resources, or both allocated for the positioning procedure, and transmits at least one positioning reference signal on the set of time and/or frequency resources allocated for the positioning procedure. The second UE receives the request to perform a positioning procedure from the first UE over the sidelink; transmits the request to perform the positioning procedure to a first network entity; receives, from a second network entity, an indication of a set of time resources, frequency resources, or both allocated for the positioning procedure; and transmits the indication to the first UE over the sidelink.

WO 2021167393 A1 a method for performing positioning in a cellular-vehicle to everything (C-V2X) system, and a device therefor. A method for performing positioning in a terminal mounted on a positioning vehicle in a C-V2X communication system according to one aspect may comprise the steps of: measuring a time of flight (ToF) by performing road side unit (RSU) and round trip time (RTT) ranging; determining a positioning mode, wherein the positioning mode includes a self-positioning mode and a cooperative positioning mode; measuring the relative positions of surrounding vehicles by using a sensor provided in the positioning vehicle on the basis of the determined positioning mode being the cooperative positioning mode, and storing first positioning measurement information corresponding to the measured relative positions; selecting a surrounding vehicle on which to perform cooperative positioning; transmitting the first positioning measurement information to the selected surrounding vehicle; receiving second positioning measurement information from the selected surrounding vehicle; and determining the current location of the positioning vehicle on the basis of the first and second positioning measurement information.

WO 2022041130 A1 discloses an apparatus comprising: an interface; a memory; and a processor, communicatively coupled to the interface and the memory, configured to: instruct a node to send a first cellular reference signal to a target UE (user equipment) and to another UE, the node being a cellular-communication node; instruct, via the interface, the target UE to report to the node a first time difference, the first time difference being a first time amount between receipt of the first cellular reference signal by the target UE and transmission of a second cellular reference signal by the target UE; and instruct, via the interface, the other UE to report a second time difference, the second time difference being a second time amount between receipt of the first cellular reference signal by the other UE and receipt of the second cellular reference signal, in a cross-link interference resource, by the other UE.

WO 2021138127 A1 discloses techniques for positioning a NR bandwidth-limited user equipment (UE) are provided. An example method of positioning performed by a bandwidth-limited UE includes transmitting a first timing measurement signal to at least one proximate premium UE, wherein the at least one proximate premium UE is capable of using more bandwidth than the bandwidth-limited UE, receiving a second timing measurement signal from the at least one proximate premium UE, and determining location information for the bandwidth-limited UE based at least on the first timing measurement signal and the second timing measurement signal.

WO 2021118756 A1 discloses techniques for positioning a bandwidth-limited user equipment (UE) are provided. An example method of positioning performed by a bandwidth-limited UE according to the disclosure includes receiving a first timing measurement signal from at least one proximate UE, wherein the at least one proximate UE is capable of using more bandwidth than the bandwidth-limited UE, and transmitting a second timing measurement signal to the at least one proximate user equipment.

US2021306979 A1 discloses Systems, methods, and devices for sidelink positioning determination and communication employing techniques including obtaining, at a first sidelink-enabled device, data from one or more data sources indicative of one or more criteria for using either round-trip time (RTT)-based positioning of a target node or single-sided (SS)-based positioning of the target node. The techniques also include selecting, with the first sidelink-enabled device, a positioning type from the group may comprise of RTT-based positioning and SS-based positioning, based on the data. The techniques also include sending a message from the first sidelink-enabled device to a second sidelink-enabled device, where the message includes information indicative of the selected positioning type.

WO 2022126496 A1 discloses devices, methods, apparatuses and computer readable storage media of retransmission of sidelink positioning reference signal (PRS). The method comprises transmitting, to a second device, a first sidelink reference signal associated with a positioning or ranging procedure of the first device; and receiving, from the second device, a second sidelink reference signal associated with the positioning or ranging procedure, the second sidelink reference signal comprising information indicating whether the first sidelink reference signal needs to be retransmitted. In this way, the retransmission of the sidelink PRS can be triggered without extra resource consumption and a fast RTT estimation for sidelink ranging and positioning can be achieved.

US2018098299 A1 discloses a method by which a user equipment (UE) performs ranging in a wireless communication system, comprising the steps of: transmitting a D2D signal in a subframe N by a first UE; receiving the D2D signal in a subframe N+K from a second UE, which has set, as a subframe boundary, a time point at which the D2D signal is received; and measuring, by the first UE, a round trip time (RTT) by detecting a reception time point of the D2D signal transmitted by the second UE.

US2021377907 A1 discloses techniques for sidelink positioning with a single anchor using distributed antenna systems. An example method for determining relative locations of two stations includes determining a first round trip time for positioning reference signals transmitted between a first station and a first antenna of a second station, determining a second round trip time for the positioning reference signals transmitted between the first station and a second antenna of the second station, wherein the first antenna and the second antenna are disposed in different locations proximate to the second station, and determining relative locations of the first station and the second station based at least in part on the first round trip time and the second round trip time.

US2022244344 A1 discloses an approach to obtain the positions of multiple user equipments (UEs), which are jointly determined by a location server using positioning measurements from a comment set of positioning reference signals (PRS), which may include downlink (DL) PRS, uplink (UL) PRS, sidelink (SL) PRS, or a combination thereof. The common set of PRS may be selected by the location server, e.g., based on a rough estimate of position of the UEs determined by the location server, a recommendation from the UEs, or a position report from the UEs. Once selected by the location server, an indication of the common set of PRS is sent to the UEs. The common set of PRS, alternatively, may be selected by one or more UEs, e.g., by a controlling UE or consensus, and one or more UEs provide an indication of the common set of PRS to the location server.

All cited prior art is based on sidelink-based positioning augmentation and RTT, but none on multi-RTT or double-sided multi-RTT. Currently, there is no way to perform multi-RTT using sidelink. Even when serving gNB is involved, SL-based multi-RTT can be useful since it provides access to additional anchor UE(s) when there are not enough neighbor gNBs or to improve accuracy of existing positioning methods. Individual uncoordinated RTT measurements to each anchor UE are time consuming and therefore the solution of this problem is given by performing multi-RTT efficiently when using SL signals.

### BRIEF DESCRIPTION OF THE DRAWINGS

FIG. 1 shows the type of TOA measurement.

FIG. 1a shows two-way ranging.

FIG. 1b shows requester sends a request packet to the responder, which replies after a response time Rj with a response packet.

FIG. 1c shows double-sided two-way ranging (Double-sided RTT).

FIG. 2 shows Multi-RTT.

FIG. 2a shows RTT measurement process to the serving base station.

FIG. 2b shows RTT measurement process to neighbor base stations.

FIG. 3 shows absolute positioning based on multi-RTT.

FIG. 3a shows the existing Multi-RTT.

FIG. 3b shows Sidelink-Aided Multi-RTT.

FIG. 4 shows the initiator when Serving gNB is Involved.

FIG. 4a shows LMF/gNB initiator.

FIG. 4b shows Target UE initiator.

FIG. 4c shows anchor UE initiator.

FIG. 5 shows the flowchart of serving gNB/LMF initiator part I.

FIG. 6 shows the flowchart of serving gNB/LMF initiator part II.

FIG. 7 shows the flowchart of serving gNB/LMF initiator part III.

FIG. 8 shows flowchart: Target UE initiator part I.

FIG. 9 shows flowchart: Target UE initiator part II.

FIG. 10 shows Flowchart: Target UE initiator part III.

### DETAILED DESCRIPTION

The detailed description set forth below, with reference to annexed drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In particular, although terminology from 3GPP 5G NR may be used in this disclosure to exemplify embodiments herein, this should not be seen as limiting the scope of the invention.

Some of the embodiments contemplated herein will now be described more fully with reference to the accompanying drawings. Other embodiments, however, are contained within the scope of the subject matter disclosed herein, the disclosed subject matter should not be construed as limited to only the embodiments set forth herein; rather, these embodiments are provided by way of example to convey the scope of the subject matter to those skilled in the art.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the following description.

In some embodiments, a more general term “network node” may be used and may correspond to any type of radio network node or any network node, which communicates with a UE (directly or via another node) and/or with another network node. Examples of network nodes are NodeB, MeNB, ENB, a network node belonging to MCG or SCG, base station (BS), multi-standard radio (MSR) radio node such as MSR BS, eNodeB, gNodeB, network controller, radio network controller (RNC), base station controller (BSC), relay, donor node controlling relay, base transceiver station (BTS), access point (AP), transmission points, transmission nodes, RRU, RRH, nodes in distributed antenna system (DAS), core network node (e.g. Mobile Switching Center (MSC), Mobility Management Entity (MME), etc), Operations & Maintenance (O&M), Operations Support System (OSS), Self Optimized Network (SON), positioning node (e.g. Evolved-Serving Mobile Location Centre (E-SMLC)), Minimization of Drive Tests (MDT), test equipment (physical node or software), etc.

In some embodiments, the non-limiting term user equipment (UE) or wireless device may be used and may refer to any type of wireless device communicating with a network node and/or with another UE in a cellular or mobile communication system. Examples of UE are target device, device to device (D2D) UE, machine type UE or UE capable of machine to machine (M2M) communication, PDA, PAD, Tablet, mobile terminals, smart phone, laptop embedded equipped (LEE), laptop mounted equipment (LME), USB dongles, UE category M1, UE category M2, ProSe UE, V2V UE, V2X UE, etc.

Additionally, terminologies such as base station/gNodeB and UE should be considered non-limiting and do in particular not imply a certain hierarchical relation between the two; in general, “gNodeB” could be considered as device 1 and “UE” could be considered as device 2 and these two devices communicate with each other over some radio channel. And in the following the transmitter or receiver could be either gNodeB (gNB), or UE.

As will be appreciated by one skilled in the art, aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects.

For example, the disclosed embodiments may be implemented as a hardware circuit comprising custom very-large-scale integration (“VLSI”) circuits or gate arrays, off-the-shelf semiconductors such as logic chips, transistors, or other discrete components. The disclosed embodiments may also be implemented in programmable hardware devices such as field programmable gate arrays, programmable array logic, programmable logic devices, or the like. As another example, the disclosed embodiments may include one or more physical or logical blocks of executable code which may, for instance, be organized as an object, procedure, or function.

Furthermore, embodiments may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In a certain embodiment, the storage devices only employ signals for accessing code.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random-access memory (“RAM”), a read-only memory (“ROM”), an erasable programmable read-only memory (“EPROM” or Flash memory), a portable compact disc read only memory (“CD-ROM”), an optical storage device, a magnetic storage device, or any suitable combination of the foregoing. In the context of this document, a computer readable storage medium may be any tangible medium that can contain or store a program for use by or in connection with an instruction execution system, apparatus, or device.

Code for carrying out operations for embodiments may be any number of lines and may be written in any combination of one or more programming languages including an object-oriented programming language such as Python, Ruby, Java, Smalltalk, C++, or the like, and conventional procedural programming languages, such as the “C” programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”), wireless LAN (“WLAN”), or a wide area network (“WAN”), or the connection may be made to an external computer (for example, through the Internet using an Internet Service Provider (“ISP”)).

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment. Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. This code may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart diagrams and/or block diagrams.

The code may also be stored in a storage device that can direct a computer, other programmable data processing apparatus, or other devices to function in a particular manner, such that the instructions stored in the storage device produce an article of manufacture including instructions which implement the function/act specified in the flowchart diagrams and/or block diagrams.

The code may also be loaded onto a computer, other programmable data processing apparatus, or other devices to cause a series of operational steps to be performed on the computer, other programmable apparatus, or other devices to produce a computer implemented process such that the code which execute on the computer or other programmable apparatus provide processes for implementing the functions/acts specified in the flowchart diagrams and/or block diagrams.

The flowchart diagrams and/or block diagrams in the Figures illustrate the architecture, functionality, and operation of possible implementations of apparatuses, systems, methods, and program products according to various embodiments. In this regard, each block in the flowchart diagrams and/or block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments of like elements.

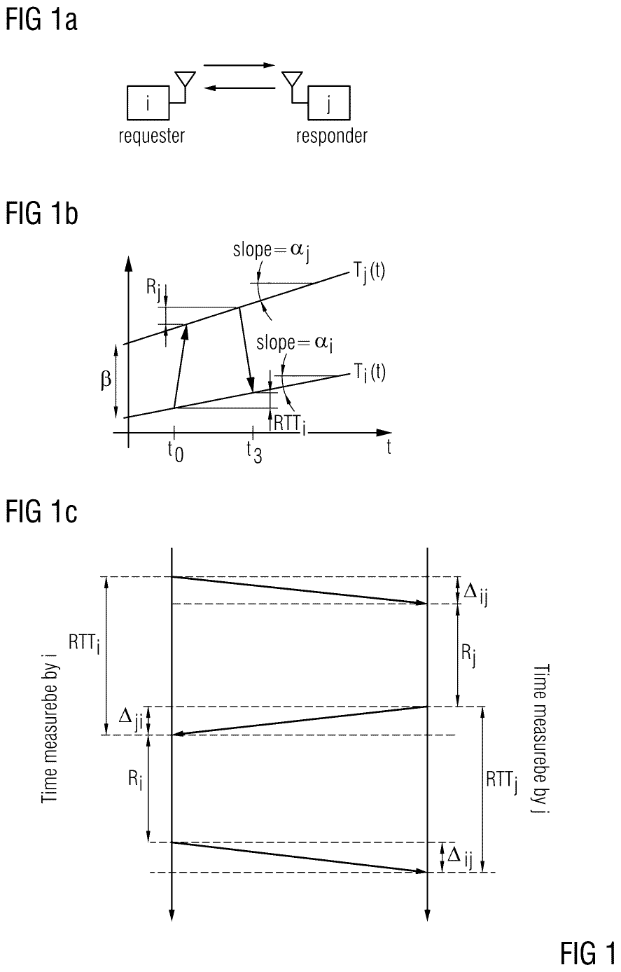

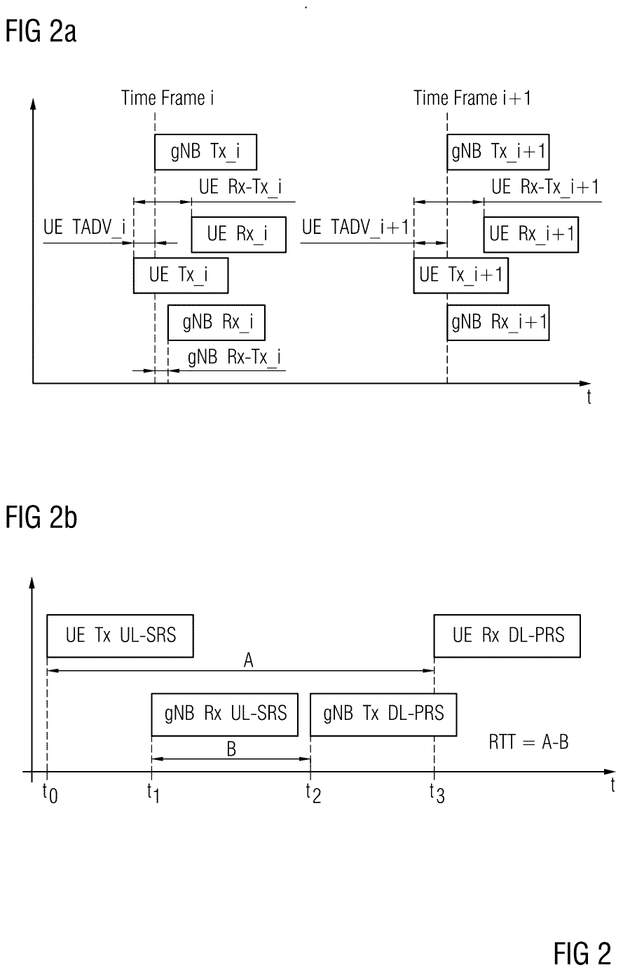

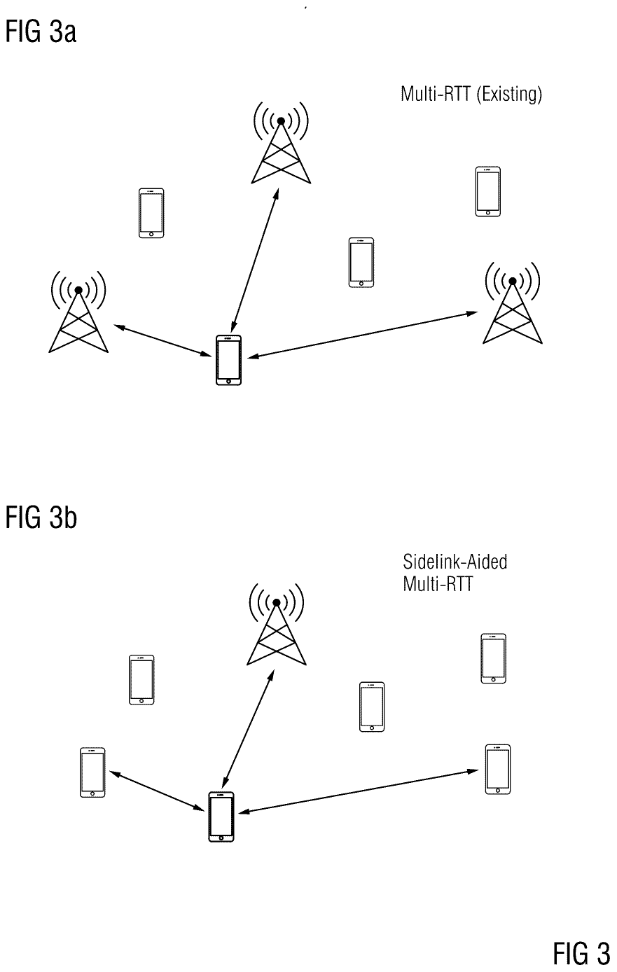

FIGS. 1 to 4 have already been described within the introduction.

By this application a method to enable single-sided or double-side multi-RTT-based positioning involving the SL in coordination with the gNB(s) is proposed.

The solution involves three novel components:

An initiator node which is responsible for identifying the anchor UE(s) and gNB(s) to be involved in the multi-RTT positioning and forwarding any resource allocation for positioning to the nodes. Furthermore a method by which the initiator can seek additional nodes for participation in multi-RTT when there are not enough nodes already known to it and a method to identify the right anchor UE(s) to be included in the multi-RTT procedure by sharing the accuracy requirement, and gracefully terminate the multi-RTT procedure if required by progressively reducing the accuracy requirement.

Beneficially, this application provides a mechanism for initiator to flexibly choose the nodes for multi-RTT. Furthermore, this application exploits capabilities of gNB/LMF fully for coordinated resource allocation. When target UE is initiator, solution enables discovery of anchor UE(s) and neighbor gNB(s) not directly known to target UE at first. When serving gNB/LMF is initiator, solution enables discovery of out-of-coverage anchor UE(s) not directly known to the gNB at first. Provides a mechanism for continuing or terminating multi-RTT in case there are not enough nodes available for multi-RTT with desired accuracy and a way to perform either single-sided or double-sided multi-RTT.

The target UE or serving gNB/LMF can forward the initiation to nodes of their choice directly if requested by the initiator; if the same approach is adopted in the SL with anchor UE(s), it would result in anchor UE(s) forwarding initiation requests to each other; hence in this case a different method is proposed so that the initiator can first select the (initially unknown) anchor UE(s) to which the initiation is to be forwarded.

The resource allocation is always done by the serving gNB with potential cooperation by other UE(s), whereas in this case, it is always done by the target UE or anchor UE, according to who initiates the procedure.

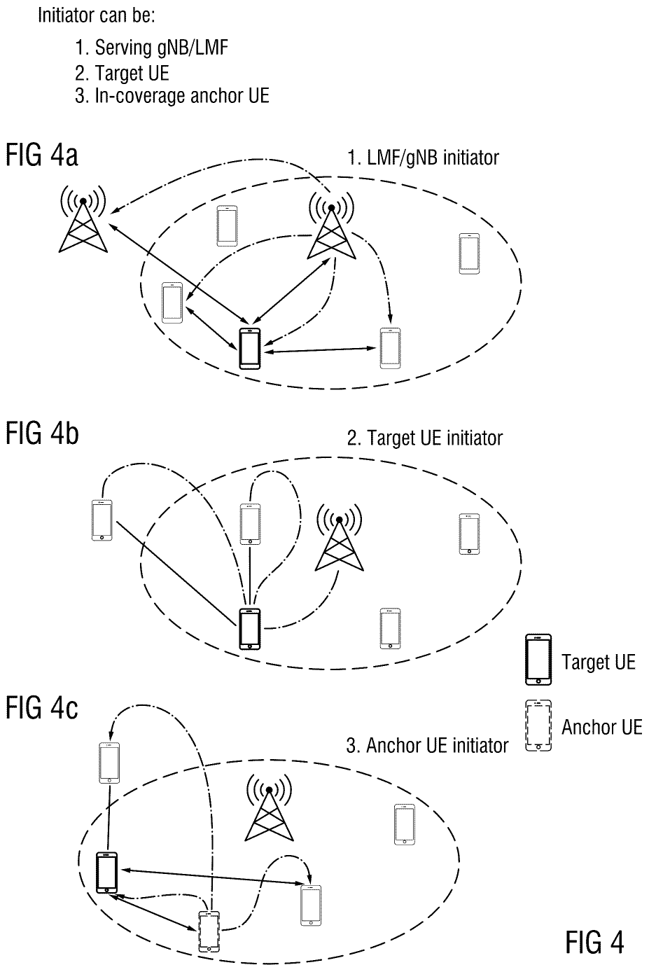

FIG. 4 shows the initiator when a serving gNB is involved, furthermore FIG. 4a shows LMF/gNB initiator, FIG. 4b shows Target UE initiator, and FIG. 4c shows anchor UE initiator.

Initiator is chosen by positioning protocol/higher layer depending on position requirement, e.g., if serving gNB/LMF requires position of a target UE in its coverage it can initiate multi-RTT, else if target UE itself needs to compute its position, it can initiate the procedure. Another possibility is if an anchor UE (e.g., an RSU) requires the position of a target in its vicinity; then the anchor UE can initiate the procedure.

Message exchanges between the nodes involved in the multi-RTT procedure are performed over NRPPa/LPP if communication is over the UL or DL. A new dedicated SL positioning protocol or directly using physical layer signaling (SCI and/or PSSCH) if communication is over the SL.

Depending on which node is initiator, three procedures presented, since the message exchange options are different according to the prior knowledge of the nodes.

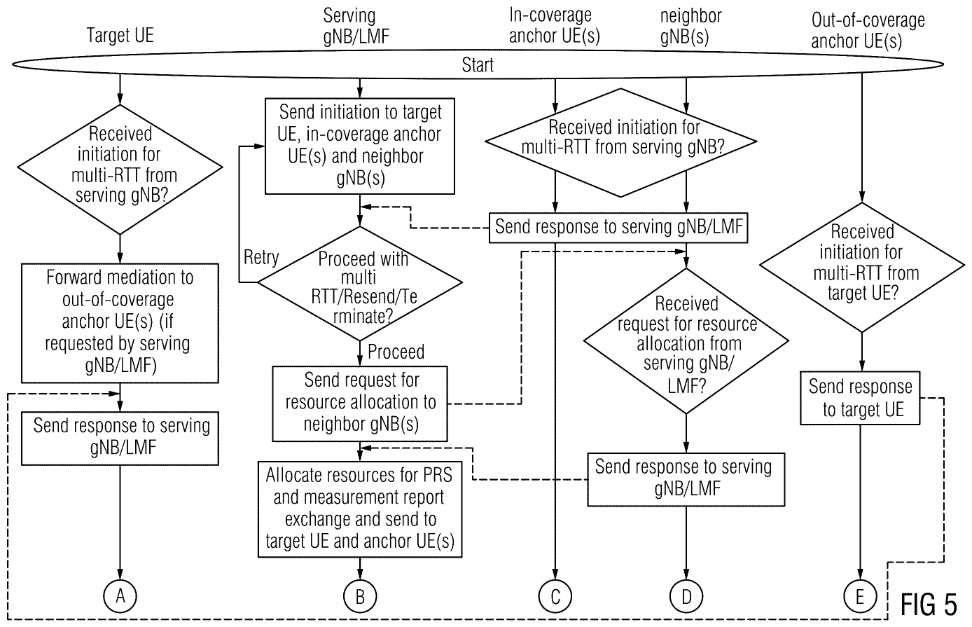

Like it is depicted in FIG. 4a and in FIGS. 5 to 7 if initiator is serving gNB/LMF, target UE, neighboring gNB(s) and in-coverage anchor UE(s) can be involved directly in multi-RTT, while out-of-coverage anchor UE(s) can be involved indirectly (via target UE). All the depicted flows named A, B, C, D, E are illustrating the functional interaction and the components of the wireless communication system. As it can be seen the components are Target UE, Serving gNB/LMF, In-coverage anchor UE(s), Neighbor gNB(s), and Out-of-coverage anchor UE(s).

Initiation for multi-RTT is transmitted to target UE, in-coverage anchor UE(s) and neighbor gNB(s), whereby which nodes other than target UE to transmit to is up to gNB implementation, depending on its prior knowledge. Initiation message to target UE includes at least the type of RTT positioning (single-sided or double sided) and whether SL aiding from other out-of-coverage anchor UE(s) is required or not. Initiation message to in-coverage anchor UE(s) includes at least type of RTT positioning, identity of target UE and accuracy requirement for anchor UE(s)′ known position and initiation message to neighbor gNB(s) includes at least type of RTT positioning and identity of target UE.

If SL aiding required by gNB/LMF, target UE forwards initiation message to neighboring out-of-coverage anchor UE(s) to which it has existing SL connection; forwarded message includes type of RTT positioning and accuracy requirement for anchor UE(s)′ known position [new].

Out-of-coverage anchor UE(s) which received forwarded initiation from target UE send their response to target UE which includes acceptance of initiation if anchor UE's own position can be known with required accuracy, else rejection. If initiation accepted, indication of current SL resources available for positioning signal exchanges with target UE [new].

Target UE, in-coverage anchor UE(s) and neighbor gNB(s) respond to initiation by serving gNB/LMF.

Response by target UE includes if SL aiding is required by gNB/LMF, information on neighboring out-of-coverage anchor UE(s) to which target UE has existing SL connection; information includes at least Position accuracy of the out-of-coverage anchor UE(s) and Request for additional SL resources for positioning with out-of-coverage anchor UE (if required) [new].

The response by neighbor gNB(s) to serving gNB/LMF includes the Acceptance/rejection of initiation depending on whether resources are available/not at neighbor gNB for supporting positioning measurements with target UE identified in initiation message. And the Response by in-coverage anchor UE(s) includes Acceptance of initiation if own position can be known with required accuracy, else rejection If initiation accepted, indication of current SL resources available for positioning signal exchanges with target UE.

The serving gNB/LMF decides to proceed, terminate or retry multi-RTT depending on the responses received. If total number of nodes that accepted initiation is less than minimum required, then serving gNB/LMF can retry initiation to nodes which rejected multi-RTT request (anchor UE(s) or neighbor gNB(s)). For neighbor gNB(s), can retry up to a certain number of times (set by serving gNB/LMF or higher layer). For in-coverage anchor UE(s), can retry with progressively reduced accuracy requirements up to a certain number of times (set by serving gNB/LMF or higher layer).

The termination of the method is done if number of retries exceeded threshold for several nodes such that minimum number of nodes requirement for multi-RTT cannot be satisfied. If total number of nodes that accepted initiation is greater than or equal to minimum required, then serving gNB/LMF proceeds with multi-RTT and can select any subset of the available nodes for further procedures [new].

If serving gNB/LMF decides to proceed with multi-RTT, it sends resource allocation request to neighbor gNB(s) based on earlier response by neighbor gNB(s).

Neighbor gNB(s) respond to serving gNB/LMF with resource allocation for DL-PRS and UL-SRS transmission between neighbor gNB(s) and target UE.

Serving gNB/LMF sends resource allocation to in-coverage anchor UE(s), target UE, and out-of-coverage anchor UE(s) (via target UE):

To in-coverage anchor UE(s), serving gNB/LMF assigns SL resources for SL-PRS transmission/reception and measurement exchange between target UE and in-coverage anchor UE(s) [new].

To target UE, serving gNB/LMF assigns DL-PRS and UL-SRS resources for PRS transmissions from and to serving gNB by target UE and physical layer resources for exchange of RTT measurements between target UE and serving gNB/LMF.

SL resources for target UE for SL-PRS transmissions and measurement exchange between target UE and (both in-coverage and out-of-coverage) anchor UE(s) over the SL [new].

If target UE requested, SL resources for out-of-coverage anchor UE(s) for SL-PRS transmissions and measurement exchange between out-of-coverage anchor UE(s) and target UE over the SL.

Serving gNB/LMF exchanges PRS signals and RTT measurements with target UE over allocated DL/UL resources; neighbor gNB(s) exchange PRS signals and RTT measurements with target UE over allocated DL/UL resources.

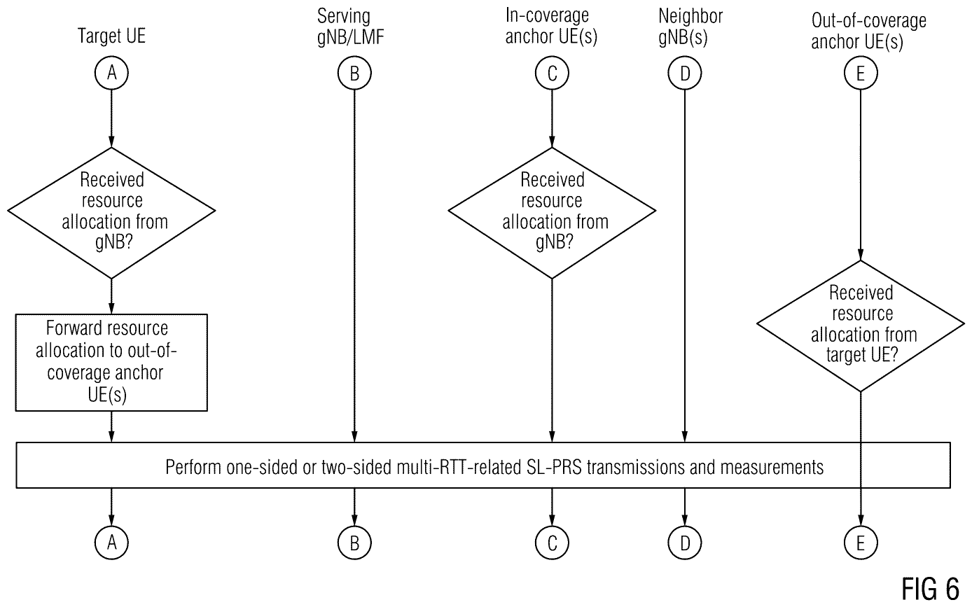

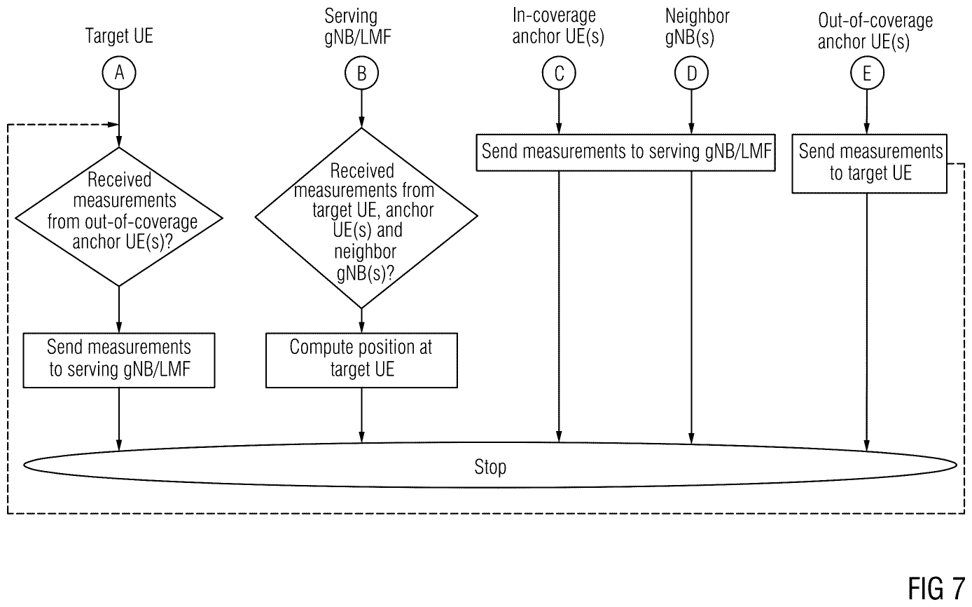

Target UE and (both in-coverage and out-of-coverage) anchor UE(s) exchange PRS signals and RTT measurements over allocated SL resources. Target UE, in-coverage anchor UE(s) and neighbor gNB(s) send their respective RTT measurements to the serving gNB/LMF. Serving gNB/LMF computes position of target UE.
FIG. 5 shows the flowchart of serving gNB/LMF initiator part I.
FIG. 6 shows the flowchart of serving gNB/LMF initiator part II.
FIG. 7 shows the flowchart of serving gNB/LMF initiator part III.

Target UE proceeds the following steps like it is illustrated by the flow A in FIGS. 5 to 7:
Is Received initiation for multi-RTT from serving gNB?
Forward initiation to out-of-coverage anchor UE(s) (if requested by serving gNB/LMF);
Send response to serving gNB/LMF;
Is Received resource allocation from gNB?
Forward resource allocation to out-of-coverage anchor UE(s);
Perform one-sided or two-sided multi-RTT-related SL-PRS transmissions and measurements;
Is Received measurements from out-of-coverage anchor UE(s)?
Send measurements to serving gNB/LMF.

Serving gNB/LMF proceeds the following steps like it is illustrated by the flow B in FIGS. 5 to 7:
Send initiation to target UE, in-coverage anchor UE(s) and neighbor gNBs;
Proceed with multi-RTT/Resend/Terminate;
Send request for resource allocation to neighbor gNB(s);
Allocate resources for PRS and measurement report exchange and send to target UE and anchor UE(s);
Perform one-sided or two-sided multi-RTT-related SL-PRS transmissions and measurements;
Received measurements from target UE, anchor UE(s) and neighbor gNB(s)?
Compute position of target UE.

In-coverage anchor UE(s) proceeds the following steps like it is illustrated by the flow C in FIGS. 5 to 7:
Received initiation for multi-RTT from serving gNB?
Send response to serving gNB/LMF;
Received resource allocation from gNB?
Perform one-sided or two-sided multi-RTT-related SL-PRS transmissions and measurements;
Send measurements to serving gNB/LMF.

Neighbor gNB(s) proceeds the following steps like it is illustrated by the flow D in FIGS. 5 to 7:
Received initiation for multi-RTT from serving gNB?
Send response to serving gNB/LMF;
Received request for resource allocation from serving gNB/LMF?
Send response to serving gNB/LMF;
Perform one-sided or two-sided multi-RTT-related SL-PRS transmissions and measurements.

Out-of-coverage anchor UE(s) proceeds the following steps like it is illustrated by the flow E in FIGS. 5 to 7:
Is Received initiation for multi-RTT from target UE?
Send response to target UE;
Is Received resource allocation from target UE?

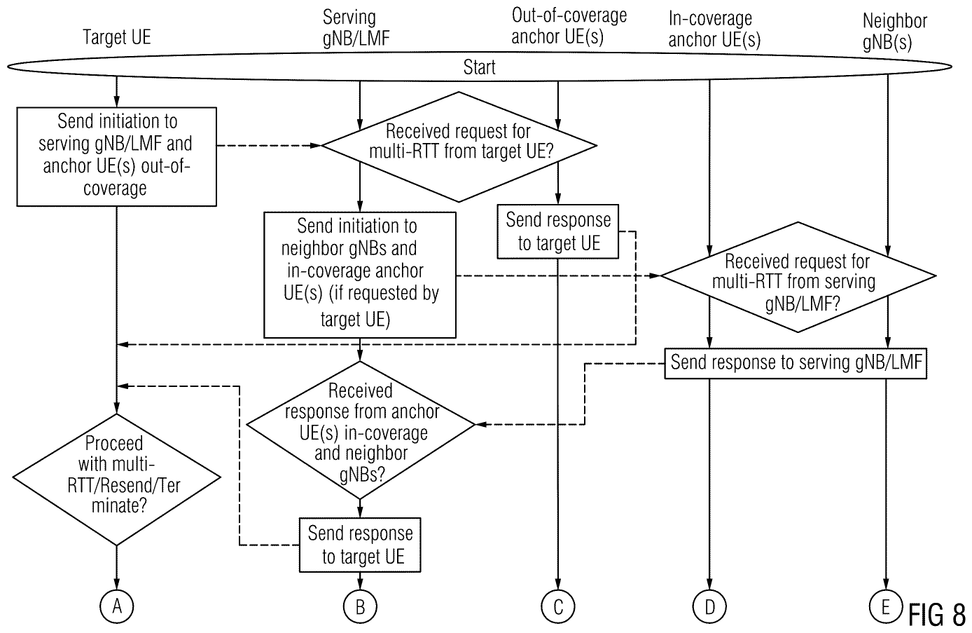

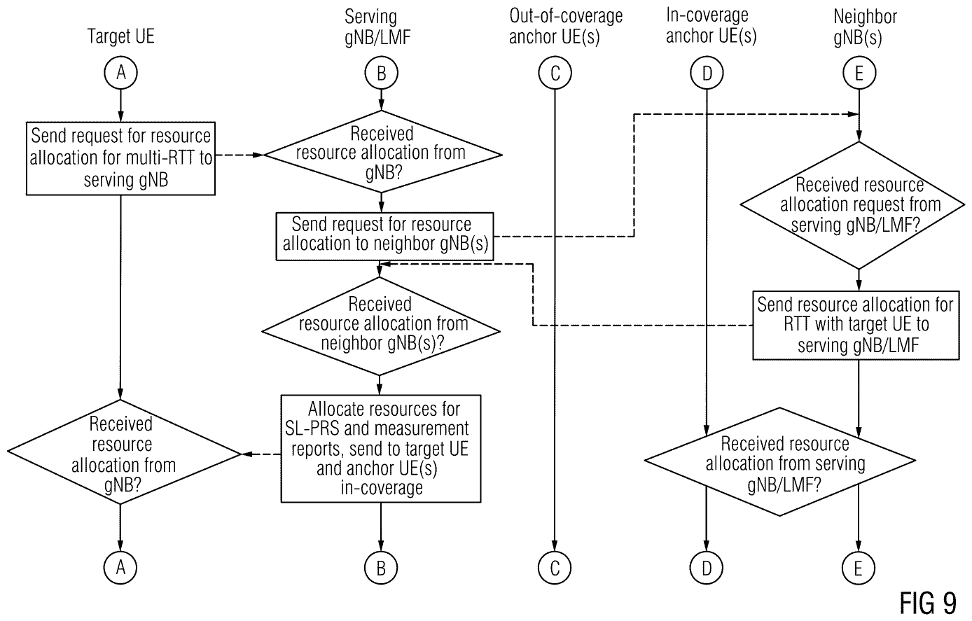

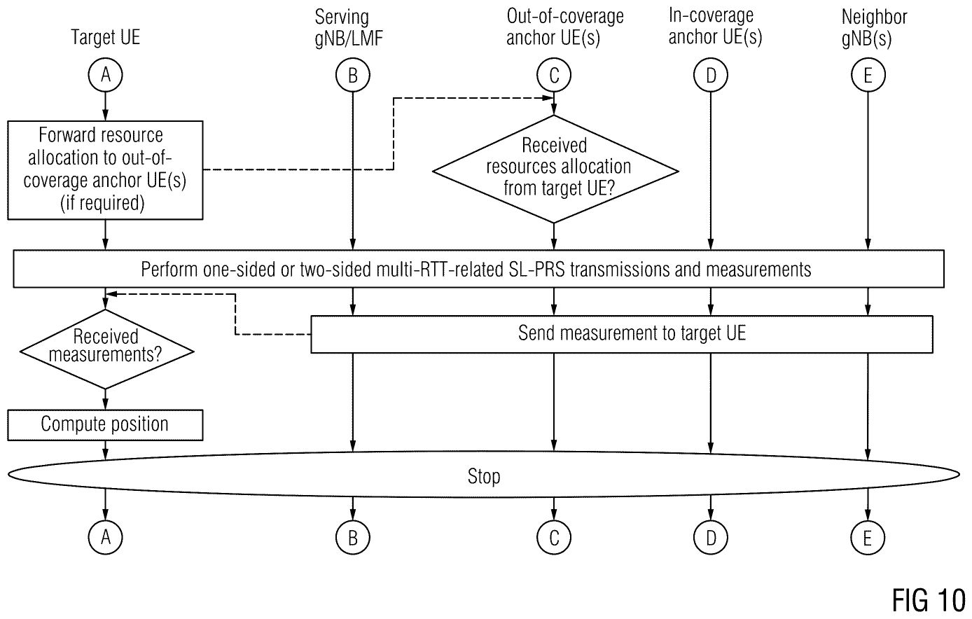

Like it is depicted in FIG. 4b and in FIGS. 8 to 10 if initiator is target UE target UE, serving gNB/LMF and anchor UE(s) known to target UE can be involved directly in multi-RTT, while neighbor gNB(s) and in-coverage anchor UE(s) unknown to target UE initially can be involved indirectly (via serving gNB/LMF). All the depicted flows named A, B, C, D, E are illustrating the functional interaction and the components of the wireless communication system. As it can be seen the components are Target UE, Serving gNB/LMF, In-coverage anchor UE(s) Neighbor gNB(s) and Out-of-coverage anchor UE(s).

Initiation is transmitted to serving gNB/LMF and out-of-coverage anchor UE(s).

Initiation message to serving gNB/LMF includes at least type of RTT positioning, Identities of anchor UE(s) known to target UE, Indication on whether initiation needs to be forwarded to other neighbor gNB(s) and/or in-coverage anchor UE(s).

Initiation message to anchor UE(s) includes at least type of RTT positioning and accuracy requirement for anchor UE(s)′ position.

If indicated by target UE, serving gNB/LMF forwards initiation message to neighbor gNB(s) and other in-coverage anchor UE(s) in proximity to target UE but not known to target UE, when forwarding initiation, serving gNB/LMF can choose preference ordering among neighbor gNB(s) and anchor UE(s) in proximity to the target UE(s). Forwarded initiation to neighbor gNB(s) contains at least type of multi-RTT positioning and identity of target UE. Forwarded initiation to in-coverage anchor UE(s) contains at least type of multi-RTT positioning, identity of target UE and position accuracy requirement.

Neighbor gNB(s) and in-coverage anchor UE(s) respond to forwarded initiation by serving gNB/LMF. Response by neighbor gNB(s) indicates acceptance/rejection of initiation depending on whether resources are available/not for positioning measurements with target UE identified in initiation message. Response includes available resources at the neighbor gNB for positioning with the target UE. Response by in-coverage anchor UE(s) includes acceptance of initiation if own position can be known with required accuracy in initiation message, else rejection, If initiation accepted, indication of current sidelink resources available for positioning signal exchanges with target UE.

Anchor UE(s) respond to initiation by target UE with acceptance if anchor UE(s)′ position can be known to desired accuracy, else rejection.

Serving gNB/LMF forwards responses by neighbor gNB(s) and in-coverage anchor UE(s) to target UE. For responses by neighbor gNB(s), serving gNB/LMF forwards total number of neighbor gNB(s) that accepted the initiation. For responses by in-coverage anchor UE(s), serving gNB/LMF forwards identity of anchor UE(s).

Anchor UE(s) respond to initiation by target UE with acceptance if anchor UE(s)′ position can be known to desired accuracy, else rejection.

Serving gNB/LMF forwards responses by neighbor gNB(s) and in-coverage anchor UE(s) to target UE. For responses by neighbor gNB(s), serving gNB/LMF forwards total number of neighbor gNB(s) that accepted the initiation. For responses by in-coverage anchor UE(s), serving gNB/LMF forwards identity of anchor UE(s).

Target UE decides to proceed, terminate or retry depending on the responses received, If total number of nodes that accepted initiation is less than minimum required, then target UE can retry initiation to nodes which rejected multi-RTT request. For anchor UE(s), can retry with progressively reduced accuracy requirements up to a certain number of times (set by higher layer of target UE). For serving gNB/LMF, can resend initiation with reduced accuracy requirements for any potential anchor UE(s) unknown to target UE, up to a certain number of times (set by higher layer of target UE).

The procedure terminates if number of retries exceeded threshold for known anchor nodes and serving gNB/LMF such that minimum number of nodes requirement for multi-RTT cannot be satisfied. If total number of nodes that accepted initiation is greater than or equal to minimum required, then target UE proceeds with multi-RTT and can select any subset of the available nodes for further procedures.

If target UE decides to proceed with multi-RTT, it sends resource allocation request to serving gNB/LMF including at least Identification of in-coverage anchor UE(s) required by target UE for participation in multi-RTT. If additional SL resources are required, request includes identification and available SL resources of out-of-coverage anchor UE(s) known to the target UE.

Serving gNB/LMF sends resource allocation request to neighbor gNB(s) based on earlier response by neighbor gNB(s).

Neighbor gNB(s) respond to serving gNB/LMF with resource allocation for DL-PRS and UL-SRS transmission between neighbor gNB(s) and target UE

Serving gNB/LMF responds to target UE and in-coverage anchor UE(s) with resource allocation. Response to target UE includes DL/UL resource allocation for target UE for DL-PRS and UL-SRS transmission between neighbor gNB(s) and target UE. SL resource allocation for target UE for SL-PRS transmission/reception and RTT measurement exchange between target UE and anchor UE(s). If target UE had requested, SL resource allocation for out-of-coverage anchor UE(s) for SL-PRS transmission/reception and RTT measurement exchange between target UE and out-of-coverage anchor UE(s).

Response to each in-coverage anchor UE includes the Resource allocation for anchor UE for SL-PRS transmission/reception and RTT measurement exchange between anchor UE and target UE.

Serving gNB/LMF exchanges PRS signals and RTT measurements with target UE over allocated DL/UL resources; neighbor gNB(s) exchange PRS signals and RTT measurements with target UE over allocated DL/UL resources.

Target UE and (in-coverage and out-of-coverage) anchor UE(s) exchange PRS signals and RTT measurements over allocated SL resources.

Serving gNB, anchor UE(s) and neighbor gNB(s) send their respective RTT measurements to target UE. Target UE computes its own position.

Target UE proceeds the following steps like it is illustrated by the flow A in FIGS. 8 to 10:
Is send initiation to serving gNB/LMF and anchor UE(s) out-of-coverage?
Proceed with multi-RTT/Resend/Terminate?
Send response to serving gNB/LMF;
Send request for resource allocation for multi-RTT to serving gNB;
Received resource allocation from gNB?
Forward resource allocation for out-of-coverage anchor UE(s) (if required);
Perform one-sided or two-sided multi-RTT-related SL-PRS transmissions and measurements;
Received measurements;
Compute position.

Serving gNB/LMF proceeds the following steps like it is illustrated by the flow B in FIGS. 8 to 10:
Received request for multi-RTT from target UE?
Send initiation to neighbor gNBs and in-coverage anchor UE(s) (if requested by target UE);
Received response from anchor UE(s) in-coverage and neighbor gNBs?
Send response to target UE;
Received resource allocation request for multi-RTT?
Send request for resource allocation to neighbor gNB(s);
Received resource allocation from neighbor gNB(s)?
Allocate resources for SL-PRS and measurement reports, send to target UE and anchor UE(s) in-coverage;
Perform one-sided or two-sided multi-RTT-related SL-PRS transmissions and measurements;
Send measurements to target UE.

Out-of-coverage anchor UE(s) proceeds the following steps like it is illustrated by the flow C in FIGS. 8 to 10:
Received request for multi-RTT from target UE?
Send response to target UE;
Received resource allocation from target UE?
Perform one-sided or two-sided multi-RTT-related SL-PRS transmissions and measurements;
Send measurements to target UE.

In-coverage anchor UE(s) proceeds the following steps like it is illustrated by the flow D in FIGS. 8 to 10:
Received request for multi-RTT from serving gNB/LMF?
Send response to serving gNB/LMF;
Received resource allocation from gNB?
Perform one-sided or two-sided multi-RTT-related SL-PRS transmissions and measurements.

Neighbor gNB(s) proceeds the following steps like it is illustrated by the flow E in FIGS. 8 to 10:
Received request for multi-RTT from serving gNB/LMF?
Send response to serving gNB/LMF;
Received resource allocation request from serving gNB/LMF?
Send resource allocation for RTT with target UE to serving gNB/LMF;
Received resource allocation from serving gNB/LMF?
Perform one-sided or two-sided multi-RTT-related SL-PRS transmissions and measurements.

Like it is depicted in FIG. 4c if initiator is in-coverage anchor UE, target UE, serving gNB/LMF and anchor UE(s) known to initiating anchor UE can be involved directly in multi-RTT, while neighbor gNB(s) and in-coverage anchor UE(s) unknown to initiating anchor UE can be involved indirectly (via serving gNB/LMF).

This embodiment is like Target UE initiator part, except that the initiation and position computation is by an in-coverage anchor UE and both target UE and serving gNB/LMF can forward the initiation to other nodes that are unknown to the initiating anchor UE but known to the target UE and serving gNB/LMF respectively.

Overall, embodiment Serving gNB/LMF initiator and Target UE Initiator would enable faster positioning since part of the information is already available at the initiating/coordinating node (gNB or target UE) in these cases; however, they require the target UE to be in coverage.

In-coverage anchor UE Initiator is important since it enables a third node other than the target or serving gNB (e.g., an RSU) to get the position of the target using multi-RTT and with potential additional access to nodes via the target UE or the gNB (if required); this is useful when the target UE is not in coverage, but the initiating anchor node is.

Another preferred embodiment of the method is characterized by, One preferred embodiment of the Methods for Sidelink-Aided multi-Round Trip Time Positioning (RTT) with at least one serving gNB involvement in a wireless communication system, characterized by, that single-sided or double-side multi-round trip time (RTT)-of wireless communication signals-based positioning involving the sidelink (SL) in the wireless communication system in coordination with at least one base-station (gNB) is proceeded by using an initiator and computes the position of target user equipment UE.

Another preferred embodiment of the method is characterized by, whereby single-sided or double-side multi-round trip time (RTT) is performed related to SL-PRS transmissions and measurements.

Another preferred embodiment of the method is characterized by, that the right anchor UE(s) to be included in the multi-RTT procedure by sharing the accuracy requirement is identified and the multi-RTT procedure is terminated if required by progressively reducing the accuracy requirement.

Another preferred embodiment of the method is characterized by, that an initiator seeks additional nodes for participation in double-side multi-RTT when there are not enough nodes already known to it.

Another preferred embodiment of the method is characterized by, that the initiator is chosen by positioning protocol or a higher layer depending on position requirement.

Another preferred embodiment of the method is characterized by, that, if serving gNB/LMF requires position of a target UE in its coverage it can initiate multi-RTT, else if target UE itself needs to compute its position, it can initiate the procedure.

Another preferred embodiment of the method is characterized by, that if an anchor UE requires the position of a target in its vicinity; then the anchor UE can initiate the procedure.

Another preferred embodiment of the method is characterized by, that the anchor UE is a road side unit (RSU).

Another preferred embodiment of the method is characterized by, that message exchanges between the nodes involved in the multi-RTT procedure are performed over a SL positioning protocol or directly using physical layer signaling if communication is over the SL.

Another preferred embodiment of the method is characterized by, characterized by, that the signaling over the SL is using the SCI and/or PSSCH and/or MAC CE.

Another preferred embodiment of the method is characterized by, that message exchanges between the nodes involved in the multi-RTT procedure are performed over a SL positioning protocol or directly using physical layer signaling if communication is over the SL.

Another preferred embodiment of the method is characterized by, that physical layer signaling is SCI and/or PSSCH and/or or MAC CE.

Another preferred embodiment of the method is characterized by, that if the initiator is serving gNB/LMF, target UE, neighboring gNB(s) and in-coverage anchor UE(s) is involved directly in multi-RTT, while out-of-coverage anchor UE(s) is involved indirectly via the target UE.

Another preferred embodiment of the method is characterized by, that if the initiator is target UE target UE, serving gNB/LMF and anchor UE(s) known to target UE is involved directly in multi-RTT, while neighbor gNB(s) and in-coverage anchor UE(s) unknown to target UE initially is involved indirectly via serving gNB/LMF.

Another preferred embodiment of the method is characterized by, that if the initiator is in-coverage anchor UE, target UE, serving gNB/LMF and anchor UE(s) known to initiating anchor UE is involved directly in multi-RTT, while neighbor gNB(s) and in-coverage anchor UE(s) unknown to initiating anchor UE is involved indirectly via serving gNB/LMF.

Another preferred embodiment is an initiator node which is responsible for identifying the anchor UE(s) and gNB(s) to be involved in the multi-RTT positioning and forwarding any resource allocation for positioning to the nodes.

One preferred embodiment is characterized by a target UE comprises a processor coupled with a memory in which computer program instructions are stored, said instructions being configured to implement steps
Is Received initiation for multi-RTT from serving gNB?
Forward initiation to out-of-coverage anchor UE(s) (if requested by serving gNB/LMF);
Send response to serving gNB/LMF;
Is Received resource allocation from gNB?
Forward resource allocation to out-of-coverage anchor UE(s);
Perform one-sided or two-sided multi-RTT-related SL-PRS transmissions and measurements;
Is Received measurements from out-of-coverage anchor UE(s)?
Send measurements to serving gNB/LMF.

One preferred embodiment is characterized by a serving gNB/LMF comprises a processor coupled with a memory in which computer program instructions are stored, said instructions being configured to implement steps
Send initiation to target UE, in-coverage anchor UE(s) and neighbor gNBs;
Proceed with multi-RTT/Resend/Terminate;
Send request for resource allocation to neighbor gNB(s);
Allocate resources for PRS and measurement report exchange and send to target UE and anchor UE(s);
Perform one-sided or two-sided multi-RTT-related SL-PRS transmissions and measurements.

One preferred embodiment is characterized by in-coverage anchor UE(s) comprises a processor coupled with a memory in which computer program instructions are stored, said instructions being configured to implement steps
Received initiation for multi-RTT from serving gNB?
Send response to serving gNB/LMF;
Received resource allocation from gNB?
Perform one-sided or two-sided multi-RTT-related SL-PRS transmissions and measurements;
Send measurements to serving gNB/LMF.

One preferred embodiment is characterized by neighbor gNB(s) comprises a processor coupled with a memory in which computer program instructions are stored, said instructions being configured to implement steps
Received initiation for multi-RTT from serving gNB?
Send response to serving gNB/LMF;
Received request for resource allocation from serving gNB/LMF?
Send response to serving gNB/LMF;
Perform one-sided or two-sided multi-RTT-related SL-PRS transmissions and measurements.

One preferred embodiment is characterized by Out-of-coverage anchor UE(s) comprises a processor coupled with a memory in which computer program instructions are stored, said instructions being configured to implement steps
Is Received initiation for multi-RTT from target UE?
Send response to target UE;
Is Received resource allocation from target UE?

One preferred embodiment is characterized by target UE proceeds comprises a processor coupled with a memory in which computer program instructions are stored, said instructions being configured to implement steps
Is send initiation to serving gNB/LMF and anchor UE(s) out-of-coverage?
Proceed with multi-RTT/Resend/Terminate?
Send response to serving gNB/LMF;
Send request for resource allocation for multi-RTT to serving gNB;
Received resource allocation from gNB?
Forward resource allocation for out-of-coverage anchor UE(s) (if required);
Perform one-sided or two-sided multi-RTT-related SL-PRS transmissions and measurements;
Received measurements;
Compute position.

One preferred embodiment is characterized by serving gNB/LMF comprises a processor coupled with a memory in which computer program instructions are stored, said instructions being configured to implement steps
Received request for multi-RTT from target UE?
Send initiation to neighbor gNBs and in-coverage anchor UE(s) (if requested by target UE);
Received response from anchor UE(s) in-coverage and neighbor gNBs?
Send response to target UE;
Received resource allocation request for multi-RTT?
Send request for resource allocation to neighbor gNB(s);
Received resource allocation from neighbor gNB(s)?
Allocate resources for SL-PRS and measurement reports, send to target UE and anchor UE(s) in-coverage;
Perform one-sided or two-sided multi-RTT-related SL-PRS transmissions and measurements;
Send measurements to target UE.

One preferred embodiment is characterized by out-of-coverage anchor UE(s) comprises a processor coupled with a memory in which computer program instructions are stored, said instructions being configured to implement steps
Received request for multi-RTT from target UE?
Send response to target UE;
Received resource allocation from target UE?
Perform one-sided or two-sided multi-RTT-related SL-PRS transmissions and measurements;
Send measurements to target UE.

One preferred embodiment is characterized by in-coverage anchor UE(s) comprises a processor coupled with a memory in which computer program instructions are stored, said instructions being configured to implement steps
Received request for multi-RTT from serving gNB/LMF?
Send response to serving gNB/LMF;
Received resource allocation from gNB?
Perform one-sided or two-sided multi-RTT-related SL-PRS transmissions and measurements.

One preferred embodiment is characterized by neighbor gNB(s) comprises a processor coupled with a memory in which computer program instructions are stored, said instructions being configured to implement steps
Received request for multi-RTT from serving gNB/LMF?
Send response to serving gNB/LMF;
Received resource allocation request from serving gNB/LMF?
Send resource allocation for RTT with target UE to serving gNB/LMF;
Received resource allocation from serving gNB/LMF?
Perform one-sided or two-sided multi-RTT-related SL-PRS transmissions and measurements.

One preferred embodiment is a wireless communication system, comprising at least one target UE according to claim 16 and/or 21, at least one serving gNB/LMF according to claim 11 and/or 22, at least one out-of-coverage anchor UE(s) according to claim 20 and/or 23, at least one In-coverage anchor UE(s) according to claim 18 and/or 24, at least one neighbor gNB(s) according to claim 19 and/or 25 being configured to implement steps of claims 1 to 4, wherein the user equipment (UE) according to claim 6 comprises a processor coupled with a memory in which computer program instructions are stored, said instructions being configured to implement steps of the claims 1 to 16, whereby within the wireless communication system a initiator according to claim 16 is implemented.

### ABBREVIATIONS

BWP Bandwidth part
CBG Code block group
CLI Cross Link Interference
CP Cyclic prefix
CQI Channel quality indicator
CPU CSI processing unit
CRB Common resource block
CRC Cyclic redundancy check
CRI CSI-RS Resource Indicator
CSI Channel state information
CSI-RS Channel state information reference signal
CSI-RSRP CSI reference signal received power
CSI-RSRQ CSI reference signal received quality
CSI-SINR CSI signal-to-noise and interference ratio
CW Codeword
DCI Downlink control information
DL Downlink
DM-RS Demodulation reference signals
DRX Discontinuous Reception
EPRE Energy per resource element
IAB-MT Integrated Access and Backhaul-Mobile Terminal
L1-RSRP Layer 1 reference signal received power
LI Layer Indicator
MCS Modulation and coding scheme
PDCCH Physical downlink control channel
PDSCH Physical downlink shared channel
PSS Primary Synchronisation signal
PUCCH Physical uplink control channel
QCL Quasi co-location
PMI Precoding Matrix Indicator
PRB Physical resource block
PRG Precoding resource block group
PRS Positioning reference signal
PT-RS Phase-tracking reference signal
RB Resource block
RBG Resource block group
RI Rank Indicator
RIV Resource indicator value
RS Reference signal
SCI Sidelink control information
SLIV Start and length indicator value
SR Scheduling Request
SRS Sounding reference signal
SS Synchronisation signal
SSS Secondary Synchronisation signal
SS-RSRP SS reference signal received power
SS-RSRQ SS reference signal received quality
SS-SINR SS signal-to-noise and interference ratio
TB Transport Block
TC Transmission Configuration Indicator
TDM Time division multiplexing
UE User equipment
UL Uplink

1. A method for Sidelink-Aided multi-Round Trip Time Positioning (RTT) with at least one serving gNB involvement in a wireless communication system, characterized by, that single-sided or double-side multi-round trip time (RTT)-of wireless communication signals-based positioning involving the sidelink (SL) in the wireless communication system in coordination with at least one base-station (gNB) is proceeded by using an initiator node and a position of a target user equipment UE is computed.

2. The method according to claim 1, whereby single-sided or double-side multi-round trip time (RTT) measurements are performed related to SL-PRS transmissions.

3. The method according to claim 1, characterized by, that one or more anchor UE(s) to be included in the multi-RTT procedure by sharing an accuracy requirement is identified and the multi-RTT procedure is terminated if required by progressively reducing the accuracy requirement.

4. The method according to claim 1, characterized by, that an initiator node seeks additional nodes for participation in double-side multi-RTT when there are not enough nodes already known to it.

5. The method according to claim 1, characterized by, that the initiator is chosen by a positioning protocol or a higher layer depending on the positioning requirement.

6. The method according to claim 5, characterized by, if serving gNB/LMF requires position of a target UE in its coverage it can initiate multi-RTT, else if target UE itself needs to compute its position, it can initiate the procedure.

7. The method according to claim 5, characterized by, that if an anchor UE requires the position of a target in its vicinity; then the anchor UE can initiate the procedure.

8. The method according to claim 7, characterized by, that the anchor UE is a road side unit (RSU).

9. The method according to claim 1, characterized by, that message exchanges between the nodes involved in the multi-RTT procedure are performed over an SL positioning protocol or directly using physical layer signaling if communication is over the SL.

10. The method according to claim 1, characterized by, that the signaling over the SL is using the SCI and/or PSSCH and/or MAC CE.

11. The method according to claim 10 characterized by, that physical layer signaling is SCI and/or PSSCH or MAC CE.

12. The method according to claim 4 characterized by, that if the initiator is the serving gNB/LMF, the target UE, neighboring gNB(s) and in-coverage anchor UE(s) if involved, are involved directly in multi-RTT, while any out-of-coverage anchor UE(s) are involved indirectly via the target UE.

13. The method according to claim 4 characterized by, that if the initiator is the target UE, then the serving gNB/LMF and the anchor UE(s) known to the target UE are involved directly in multi-RTT, while any neighbor gNB(s) and in-coverage anchor UE(s) unknown to the target UE initially are involved indirectly via the serving gNB/LMF.

14. The method according to claim 4 characterized by, that if the initiator is an in-coverage anchor UE, the target UE, serving gNB/LMF and anchor UE(s) known to the initiating anchor UE are involved directly in multi-RTT, while any neighbor gNB(s) and in-coverage anchor UE(s) unknown to the initiating anchor UE are involved indirectly via the serving gNB/LMF.

15. An initiator node which is responsible for identifying anchor UE(s) and gNB(s) to be involved in a multi-RTT positioning and forwarding any resource allocation for positioning to the nodes.

16. A target UE comprises a processor coupled with a non-transitory memory in which computer program instructions are stored, said instructions being configured to perform operations comprising:
Is Received initiation for multi-RTT from serving gNB?
Forward initiation to out-of-coverage anchor UE(s) (if requested by serving gNB/LMF);
Send response to serving gNB/LMF;
Is Received resource allocation from gNB?
Forward resource allocation to out-of-coverage anchor UE(s);
Perform one-sided or two-sided multi-RTT-related SL-PRS transmissions and measurements;
Is Received measurements from out-of-coverage anchor UE(s)? and
Send measurements to serving gNB/LMF;

17. A serving gNB/LMF comprises a processor coupled with a non-transitory memory in which computer program instructions are stored, said instructions being configured to perform operations comprising:
Send initiation to target UE, in-coverage anchor UE(s) and neighbor gNBs;
Proceed with multi-RTT/Resend/Terminate;
Send request for resource allocation to neighbor gNB(s);
Allocate resources for PRS and measurement report exchange and send to target UE and anchor UE(s); and
Perform one-sided or two-sided multi-RTT-related SL-PRS transmissions and measurements,

18. An in-coverage anchor UE comprises a processor coupled with a non-transitory memory in which computer program instructions are stored, said instructions being configured to perform operations comprising:
Received initiation for multi-RTT from serving gNB?
Send response to serving gNB/LMF;
Received resource allocation from gNB?
Perform one-sided or two-sided multi-RTT-related SL-PRS transmissions and measurements; and
Send measurements to serving gNB/LMF.

19. A neighbor gNB comprises a processor coupled with a non-transitory memory in which computer program instructions are stored, said instructions being configured to perform operations comprising:
Received initiation for multi-RTT from serving gNB?
Send response to serving gNB/LMF;
Received request for resource allocation from serving gNB/LMF?
Send response to serving gNB/LMF; and
Perform one-sided or two-sided multi-RTT-related SL-PRS transmissions and measurements.

20. An out-of-coverage anchor UE comprises a processor coupled with a non-transitory memory in which computer program instructions are stored, said instructions being configured to perform operations comprising:
Is Received initiation for multi-RTT from target UE?
Send response to target UE; and
Is Received resource allocation from target UE?

21. A target UE comprises a processor coupled with a non-transitory memory in which computer program instructions are stored, said instructions being configured to perform operations comprising:
Is send initiation to serving gNB/LMF and anchor UE(s) out-of-coverage?
Proceed with multi-RTT/Resend/Terminate?
Send response to serving gNB/LMF;
Send request for resource allocation for multi-RTT to serving gNB;
Received resource allocation from gNB?
Forward resource allocation for out-of-coverage anchor UE(s) (if required);
Perform one-sided or two-sided multi-RTT-related SL-PRS transmissions and measurements;
Received measurements; and
Compute position.

22. A serving gNB/LMF comprises a processor coupled with a non-transitory memory in which computer program instructions are stored, said instructions being configured to perform operations comprising:
Received request for multi-RTT from target UE?
Send initiation to neighbor gNBs and in-coverage anchor UE(s) (if requested by target UE);
Received response from anchor UE(s) in-coverage and neighbor gNBs?
Send response to target UE;
Received resource allocation request for multi-RTT?
Send request for resource allocation to neighbor gNB(s);
Received resource allocation from neighbor gNB(s)?
Allocate resources for SL-PRS and measurement reports, send to target UE and anchor UE(s) in-coverage;
Perform one-sided or two-sided multi-RTT-related SL-PRS transmissions and measurements; and
Send measurements to target UE.

23. An out-of-coverage anchor UE comprises a processor coupled with a non-transitory memory in which computer program instructions are stored, said instructions being configured to perform operations comprising:
Received request for multi-RTT from target UE?
Send response to target UE;
Received resource allocation from target UE?
Perform one-sided or two-sided multi-RTT-related SL-PRS transmissions and measurements; and
Send measurements to target UE.

24. An in-coverage anchor UE comprises a processor coupled with a non-transitory memory in which computer program instructions are stored, said instructions being configured to perform operations comprising:
Received request for multi-RTT from serving gNB/LMF?
Send response to serving gNB/LMF:
Received resource allocation from gNB? and
Perform one-sided or two-sided multi-RTT-related SL-PRS transmissions and measurements,

25. A neighbor gNB comprises a processor coupled with a non-transitory memory in which computer program instructions are stored, said instructions being configured to perform operations comprising:
Received request for multi-RTT from serving gNB/LMF?
Send response to serving gNB/LMF;
Received resource allocation request from serving gNB/LMF?
Send resource allocation for RTT with target UE to serving gNB/LMF;
Received resource allocation from serving gNB/LMF? and
Perform one-sided or two-sided multi-RTT-related SL-PRS transmissions and measurements,

26. (canceled)
